(19) United States
(12) Patent Application Publication
(10) Pub. No.: US 2007/0097389 A1
(43) Pub. Date: May 3, 2007

(54) Color set mapping

(75) Inventor: Jan Morovic, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/260,310

(22) Filed: Oct. 28, 2005

(51) Int. Cl. H04N 1/60

(52) U.S. Cl. 358/1.9

(57) ABSTRACT

A method of mapping a set of individual colors having a color set gamut with a color-set gamut boundary. Some of the colors of the color set are not reproducible by a reproduction device, which has a color gamut with a gamut boundary, and are therefore outside the reproduction device's color gamut. The set of individual colors is mapped to a reproducible-color set. The method includes compressing the in-gamut colors, and clipping the out-of-gamut colors onto the device's gamut boundary along lines derived from both of the set gamut boundary and the device's gamut boundary.

### FIELD OF THE INVENTION

The present invention relates generally to color mapping, and for example, to a method of mapping a set of individual colors and to a digital representation of a customized set of such colors.

### BACKGROUND OF THE INVENTION

Since describing colors by mere words lacks precision, professionals, such as the manufacturers of ink or paint and the designers or artists that finally use these products, prefer to use collections of color samples as a reference. Such color catalogues exist in standardized form as color systems, like the Pantone or the Munsell color systems for example, or in custom form as, e.g., sets of corporate identity colors and instead of trying to characterize a color in mind as, for instance, a “rather reddish not so dark yellow”, one can look up a swatch-book and identify this color precisely as “PANTONE 1485 C”, “TOYO 0171”, “ANPA 750-6 AdPro”, “Acme Corporate Color: Salmon” or a color from some other standard or custom color system. Using such names, and either a production formula or a physical reference related to the name by the color catalogue, a color manufacturer can brew and deliver an ink, or other colorant, that matches the special color in mind.

Image reproduction devices like printers, displays or projectors use a limited number of colorants, and colors of an image to be reproduced, that are not matched by one of these colorants, are mixed, or simulated at the device's output; an LCD display for instance uses three subpixels of variable intensity with red, green and blue (RGB) filters to create a single colored pixel, printers can evoke the impression of a multitude of colors using cyan, magenta, yellow and black (CMYK) or other colorant sets by halftoning.

Image reproduction devices, however, cannot simulate all the colors a typical set of catalogue colors such as ones by Pantone, Toyo, Munsell, HKS or NCS contains. In terms of color science one would say that certain elements of the set of (for instance Toyo) catalogue colors are not within a reproduction device's color gamut. The set of all the colors of such color catalogues, like the swatch books made by Pantone or Toyo, thus typically have a color gamut larger than the color gamuts of digital output imaging systems (e.g. printers, displays, projection).

If a set of colors, for instance a set of individual catalogue colors or a set of all the colors of an image, is to be reproduced and the set contains colors that are not reproducible by a device, this set containing out-of-gamut colors is replaced by a set containing only reproducible, in-gamut colors, i.e. out-of-gamut colors are mapped to colors within the reproduction device's gamut. There is a variety of mapping methods, which can be basically categorized by the terms of clipping and compression. Clipping methods specify a mapping criterion, which is used for finding a point on the reproduction device's gamut boundary to which a given out-of-gamut color is mapped; in-gamut colors are kept unchanged. Compression methods are applied to all colors of a set of colors to be reproduced, thereby distributing these changes across the entire range. It is also known in the art to combine these basic mapping methods of clipping and compressing.

An article by Lindsay MacDonald, Jan Morovic and Kaida Xiao, “A Topographic Gamut Compression Algorithm” (Journal of Imaging Science and Technology, Volume 46, Number 1, January/February 2002) discloses a compression method for continuous colors wherein a reduced gamut (called ‘core gamut’) is constructed inside a device gamut boundary. No compression occurs inside the core gamut, i.e. color is preserved unchanged. Colors outside the device gamut are compressed into the region between the core and the device gamut. To this end, a gamut boundary curve is defined as the intersection of the gamut boundary and a plane of constant hue for both a source gamut and the core gamut. A path length is defined on these gamut boundary curves, relative to the total length of the paths connecting the white and black points. The compression is performed by shifting a point representing an out-of-gamut color into the region between the core and the device gamut along a line, which goes through the point and intersects the source gamut boundary curve and the core gamut boundary at the same relative path lengths.

### SUMMARY OF THE INVENTION

A method is provided of mapping a set of individual colors having a color set gamut with a color-set gamut boundary. Some of the colors of the color set are not reproducible by a reproduction device, which has a color gamut with a gamut boundary, and are therefore outside the reproduction device's color gamut. The set of individual colors is mapped to a reproducible-color set. The method comprises compressing the in-gamut colors, and clipping the out-of-gamut colors onto the device's gamut boundary along lines derived from both of the set gamut boundary and the device's gamut boundary.

According to another aspect, a method is provided of mapping a set of individual colors having a color set gamut with a color set gamut boundary. Some of the colors of the color set are not reproducible by a reproduction, which has a color gamut with a gamut boundary, and are therefore outside the reproduction device's color gamut. The set of individual colors is mapped to a reproducible-color set. The method comprises clipping the out-of-gamut colors onto the device's gamut boundary, and performing a clipped-color adjustment towards the original colors, depending on the local slope of the device gamut boundary.

According to another aspect, a digital representation of a set of standard colors is provided. It is either in the form of a machine-readable medium with the color representations stored on it, or in the form of a propagated signal comprising the color representations. The set of standard colors is customized for a reproduction device having a color gamut with a gamut boundary, by mapping an original set of standard colors having a color set gamut with a color set gamut boundary to the customized set of standard colors. Some of the colors of the original color set are not reproducible by the reproduction device, and are therefore outside the reproduction device's color gamut. The mapping is defined by comprising: compressing the in-gamut colors, and clipping the out-of-gamut colors onto the device's gamut boundary along lines derived from both of the set gamut boundary and the device's gamut boundary.

According to another aspect, a digital representation of a set of standard colors is provided. It is either in the form of a machine-readable medium with the color representations stored on it, or in the form of a propagated signal comprising the color representations. The set of standard colors is customized for a reproduction device having a color gamut with a gamut boundary, by mapping an original set of standard colors having a color set gamut with a color set gamut boundary to the customized set of standard colors. Some of the colors of the original color set are not reproducible by the reproduction device, and are therefore outside the reproduction device's color gamut. The mapping is defined by comprising: clipping the out-of-gamut colors onto the device's gamut boundary, and performing a clipped-color adjustment towards the original colors, depending on the local slope of the device gamut boundary.

Other features are inherent in the methods and products disclosed or will become apparent to those skilled in the art from the following detailed description of embodiments and its accompanying drawings.

### BRIEF DESCRIPTION OF THE DRAWINGS

Embodiments of the invention will now be described, by way of example, and with reference to the accompanying drawings, in which:

FIG. 1 shows a chroma-lightness diagram of a set of catalogue colors in a plane of a constant hue, including a polygon representing the intersection of a reproduction device's gamut boundary with this plane of constant hue;

FIG. 2 shows the diagram of FIG. 1, further comprising a polygon representing the intersection of the boundary of the color set's gamut with the plane of constant hue;

FIG. 3 shows, in a chroma-lightness diagram, an embodiment of the compression of in-gamut colors;

FIG. 4 shows, in a chroma-lightness diagram, an embodiment of the out-of-gamut color clipping based on the device gamut boundary and the color set gamut boundary;

FIG. 5 shows, in a chroma-lightness diagram, an exemplary result of the out-of-gamut clipping described with reference to FIG. 4.

FIG. 6 shows, in a chroma-lightness diagram, an exemplary result of a color mapping comprising an in-gamut compression and an out-of-gamut clipping.

FIG. 7 shows, in a chroma-lightness diagram, an embodiment of a clipped-color adjustment, which is performed in regions of flat slope and in regions of steep slope of a gamut boundary curve;

FIG. 8 shows a block diagram of a system for mapping a set of catalogue colors into a reproduction device's gamut, the mapped color set being transformed into a viewable and/or printable digital swatch book;

FIG. 9 schematically shows a set of mapped standard colors and pages of a digital swatch book visualizing these mapped standard colors;

The drawings and the description of the drawings relate to embodiments of the invention and not to the invention itself.

### DESCRIPTION OF THE PREFERRED EMBODIMENTS

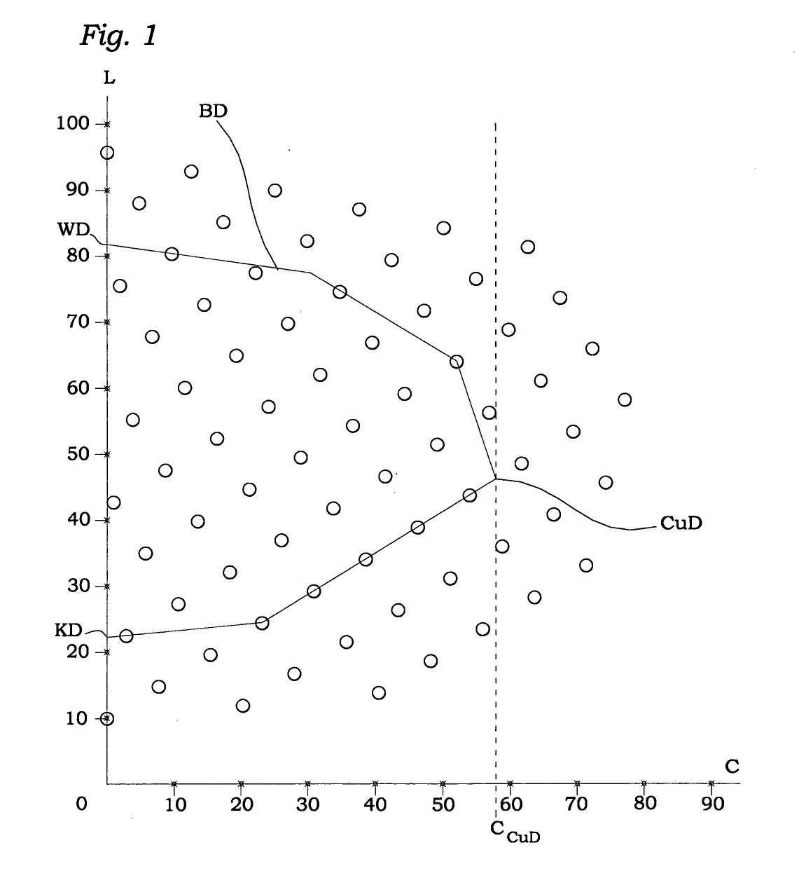

FIG. 1 shows a chroma-lightness diagram of a set of standard colors in a plane of a constant hue. Before proceeding further with the detailed description of FIG. 1, however, a few items of the embodiments will be discussed.

As mentioned at the outset, the real world offers a continuum of colors, but a reproduction system such as a printing system, which for example is the combination of a certain printer (like an offset press, a laser or an inkjet printer), ink (or whatever colorant) and media (like glossy paper or canvas), samples only a subset of them consisting of a finite number of individual colors.

To provide a common reference system for professionals dealing with colors, standard color catalogues such as those of the Pantone, Toyo or NCS colors are used when referring to particular colors. Alternatively, custom color catalogues can also be defined, such as catalogues of a company's corporate identity colors. Such catalogue colors are used mainly where color precision is emphasized over pictorial qualities, as for the creation and reproduction of graphical elements like corporate logos or signs, for industrial and interior design, in the textile and packaging industry, and so on. Since the color catalogue's colors are defined either as mixtures of specific colorants or by physical references, this helps ensure the consistency of a product's color appearance and that any graphical element matches the designer's intention—as long as each single color of an image is produced using a colorant of that color. The swatches printed in a color catalogue's swatch-books are samples of “the real thing”, referred to as solid or spot colors, whereas colors simulated by a combination of a small number of colorants through, for instance, a halftoning process on an offset press are so called process colors.

An aim of the gamut-related color mapping of some of the embodiments is to ensure a good correspondence of overall color appearance between the original color set and the reproduced color set by compensating for the mismatch in the size, shape and location between the original gamut of the color catalogue and the gamut of the reproduction device. As a number of colors are physically not reproducible by any given reproduction device, some of the embodiments aim for a match of the color set's overall appearance rather than the appearance of individual colors which is impossible for some original colors (namely the out-of-gamut colors).

In general, the reproduction device's gamut is a subspace of the color space representing the whole of visible colors. All the visible colors can be represented by points in a three-dimensional color space (LCH), wherein each unique color is identified by a triple of values predicting its lightness (L), chroma (C) and hue (H). Hue is often represented on a color wheel, ranging from red through yellow, green and blue and back to red, with corresponding hue angles, ranging from 0 to 360 degrees. A color's hue stands for its similarity to “one, or a proportion of two, of the perceived colors, red, yellow, green, and blue” (according to a definition by R. W. G. Hunt).

The term lightness refers to a color's relative position on a scale whose extremes are black (0) and white (100), chroma values predict the extent to which a color's hue is manifested, ranging from grey (0) to highly chromatic colors on an open-ended scale.

The three-dimensional color space (LCH) is defined by three axes: one achromatic axis (L), representing the lightness values of the colors, and two chromatic axes (a, b), one of them (a) ranging from highly chromatic green through grey to highly chromatic red, the other chromatic axis (b) ranging from highly chromatic blue through grey to highly chromatic yellow. Based on this coordinate system any possible visible color can be labeled by a unique set of three Cartesian coordinates (L, a, b), (L) representing its lightness-value and (a) and (b) together representing its hue and chroma wherein (a) and (b) are orthogonal dimensions whose polar equivalents are a hue (an angle) and chroma (a distance from the lightness axis).

Throughout this description, two distinct subspaces of the color space are to be distinguished. First, the device's color gamut which is the set of all colors a device can reproduce, and second, the color set gamut, which is a subspace of the color space comprising all colors of a given set of catalogue colors (e.g. the colors of the Pantone, Toyo, Munsell or NCS systems).

The surface of the device gamut, the device gamut's boundary, separates the visible though not reproducible out-of-gamut colors from the visible and reproducible in-gamut colors. The surface of the color set gamut thus neatly encloses all colors of the set of catalogue colors.

One way to define a gamut boundary is by its extremes in the achievable values of the pair chroma/lightness at all of the color space's hues. The boundary can be described mathematically, for instance, by multivariable equations, forming three-dimensional curved hulls. Another mathematical description utilized in some embodiments is based on points which represent the colors with extreme chroma- and lightness-values (or values that are extreme in terms of other dimensions derived from LCH); these points are then used as corner points (vertices) of an interpolated polyhedron surface approximating the reproduction device's gamut boundary or the color set's gamut boundary. Regarding the device gamut, these points represent the, or a selection of the, extreme chroma- and lightness-values the device can reproduce at the color space's different hues. These points can for example, be derived empirically, for instance by analyzing test reproductions of color targets produced by the device. Regarding the color set gamut, these points represent the, or a selection of the, colors of the original color set with extreme chroma- and lightness-values.

As mentioned above, if a set of colors is to be reproduced by a device and colors within this set are not within the device's gamut, this set is mapped to a set of colors which all are reproducible. The set of the mapped colors however will always differ from the set of the original colors, and the differences vary with the applied mapping methods in regard to which properties of the set undergo alterations and to what extent. In some embodiments, the set of standard colors is mapped to reproducible colors (i.e. into the device's gamut and onto the device's gamut boundary) by compressing the in-gamut colors and by clipping the out-of-gamut colors onto the device's gamut boundary.

In some of the embodiments (which are described below with reference to the figures), compressing and clipping is performed in a hue-invariant way, so that these steps can be visualized in two-dimensional chroma-lightness-diagrams representing slices of constant hue in the color space. In alternative embodiments, the mapping methods described below in more detail may be applied to known hue-non-conserving methods.

In general, the intersection of the gamut boundary with a plane of constant hue defines a gamut boundary curve in a two-dimensional plane. The gamut boundary curve connects a white point and a black point of the color space which are both situated on the L-axis comprising the zero-chroma colors (gray levels). The chroma maximum of a gamut boundary in a L-C graph is denoted as the gamut's ‘cusp’. The term ‘cusp’ thus refers to the color with maximum chroma at a given hue.

In some embodiments, the compressing of in-gamut colors, at a given hue, is made by reducing an in-gamut color's chroma value without changing its lightness value. In some of these embodiments, this is achieved by scaling the chroma value of an in-gamut color by a given scaling factor. This scaling factor is, for example, the ratio of the chroma value of the cusp of the device gamut and the chroma value of the cusp of the color set gamut, at the given hue. Since, normally, for all hue values, the cusp of the device gamut has a smaller chroma value than the cusp of the color set gamut, the scaling factor is smaller than one, resulting in a chroma compression of the in-gamut colors.

In some embodiments, the clipping the out-of-gamut colors onto the device's gamut boundary is performed along lines in the constant-hue plane which are derived from both of the color set gamut boundary and the device gamut boundary. In some of these embodiments, these lines are determined by defining a path length on the device gamut boundary curve and on the color set gamut boundary curve relative to the total length of the respective gamut boundary curve. To achieve this, the white point of the gamut can be assumed as the starting point (relative path length zero) of the path, and the black point can be assumed as the end point (relative path length 1) of the path. The clipping of a particular out-of-gamut color is then performed by shifting the point representing this color onto the device gamut boundary along a line, which goes through this point and which intersects the color set gamut boundary curve and the device gamut boundary curve at the same relative path length. Due to the above definition of path lengths on the gamut boundary curves, there is only one unique line per out-of-gamut point in color space.

The described compressing and clipping results in a mapped set of colors which are all situated inside the reproduction device's color gamut and which are thus all reproducible by the reproduction device. It can be considered as a compromise between the aims to preserve the structure and appearance of the original set of standard colors (by maintaining, to a certain approximate extent, the relative differences of the colors within the set of colors) and to exploit the available color gamut of the reproduction device (in a better way than is usually achieved, for example, by compression algorithms which map the out-of-gamut colors inside the device gamut, because a lot of the outer device gamut is then used up to accommodate a few far-out out-of-gamut colors of the original color set).

Even though in the present description of some embodiments the compression is described before the clipping, the result of the mapping does not depend on the particular order of these two activities (considering that colors, which are originally in-gamut are treated separately from those that are out-of-gamut and that the treatment of these two types of colors is independent of each other), and the description is thus meant to also represent the reversed order.

In some embodiments, the clipping is followed by an “adjustment”: The out-of-gamut colors are clipped onto the device's gamut boundary, and clipped-color adjustment is then performed towards the original colors, depending on the slope of the device gamut boundary curve at the point representing the clipped color.

The clipped-color adjustment is performed by shifting the point representing the clipped color along the gamut boundary towards the original catalogue color. In some embodiments, the clipped-color is adjusted by shifting it along the gamut boundary curve to a point of either minimum lightness or minimum chroma difference from the original color. In other embodiments, the adjustment is not made the whole way from the original clipping result to the minimum-difference point, but only a certain fraction of it, to an intermediate point between the original clipping result to the minimum-difference point. The fraction may, for example be 0.5, or a smaller (e.g. 0.25) or bigger (e.g. 0.75) value.

Typically, a gamut boundary curve has regions of flatter, intermediate and steeper slopes. Here, the term ‘slope’ of a gamut boundary curve refers to the slope ΔL/ΔC of the gamut boundary curve in the L-C-graph. In some embodiments, the clipped-color adjustment towards the original colors is performed in at least one such region of flatter slope and/or of steeper slope, and the clipped-color adjustment is not performed, or is only performed to a lesser extent, in regions of intermediate slope. In some of the embodiments, exemplary values for ‘flatter slope’ where the adjustment is made are ‘smaller or equal 0.2’, and exemplary values for ‘steeper slope’ (where the adjustment is also made, in some embodiments) are ‘greater or equal 5’. In alternative embodiments, other slope values are chosen to define where the adjustment is made, for example 0.1/10, or 0.3/4, etc.

The idea behind this sort of slope-dependent adjustment is that, if the slope is steep (ΔL/ΔC is large), large changes in lightness go with small changes in chroma, so that the lightness value of a clipping result may be adjusted closer to the lightness of the original color, nearly without changing the chroma value. Analogously, if the slope is flat (ΔL/ΔC is small), small changes in lightness go with large changes in chroma, so that the chroma value of a clipping result may be adjusted closer to the chroma value of the original color, nearly without changing the lightness value. In other words, the clipping result is modified towards the original color by changing only one of the two color parameters, without (significantly) changing the other one. In regions of intermediate slope where both color parameters would vary together, no such adjustment is made, or it is only made to a lesser extent.

This sort of clipping-result adjustment can be considered as a compromise between the aims to preserve the structure and appearance of the original set of catalogue colors and to reproduce the original colors in a color-true manner. As already mentioned above, in view of this compromise feature, this adjustment may be applied to any clipping method, with or without compression.

This sort of color adjustment may be applied to the clipping result of any known clipping method. For example, in some embodiments it is applied to a minimum distance clipping method. The color adjustment may be applied to any clipping method, irrespective of whether the clipping method is combined with a compression of the in-gamut colors, or not.

In some of the embodiments, however, the color adjustment is applied to the relative-path-length-conserving clipping method described above (and in more detail below), with or without compression of in-gamut colors. In some of these embodiments, this is, in turn, combined with the lightness-preserving compression method of the in-gamut colors described above (and in more detail below).

In some of the embodiments both the relative-path-length-conserving clipping method described above (with or without the lightness-conserving compression method described above) and the clipping-result adjustment are combined. This can be considered a compromise between the aims to preserve the structure and appearance of the original set of catalogue colors, to exploit the available color gamut of the reproduction device, and to reproduce the original colors in a color-true manner.

Embodiments are also described of the results of the mapping methods, namely digital representations of a set of catalogue colors (these may also be called ‘digital swatch books’). Such a resulting color set is adapted, or ‘customized’, to a certain reproduction device's gamut (actually, in the case of a printer, the device gamut may also depend on the reproduction media (e.g. paper), colorants (e.g. inks) and printer driver software settings used and on the viewing conditions under which the resulting print is seen; thus, the resulting color set may be customized to a certain device-colorants-media-settings-viewing combination; for other imaging devices there are similar parameters too).

Some embodiments of a digital swatch books include a machine-readable medium on which the data representing the colors of the swatch book is stored. A “machine-readable medium” is any medium that is capable of storing or encoding data representing the colors. The term “machine-readable medium” shall accordingly be taken to include, for example, solid state memories and, removable and non-removable, optical and magnetic storage media.

A representation of the digital swatch book in the form of a propagated signal is an embodiment, which enables the swatch-book data to be distributed over a network, such as the Internet or a private network. As with software in general, this is likely to become the usual way of transmitting and distributing digital swatch books.

A digital swatch book is a data product which may be sold together with the reproduction device to which it is customized, or together with a graphics application which enable a simulation of the customized swatch book (e.g. its ‘softproof’ display on a workstation's display), but it may also be commercialized by swatch book designers etc. without hardware or other software.

The reproduction system of some embodiments to which the swatch book is customized is a printing, display, projection or other imaging device, which is able to reproduce color images on a reproduction media, such as itself (display), paper (printer) or a screen (projector). A printing device to which the swatch book is customized is, for example, an ink-jet printer, e.g. thermal or piezo drop-on-demand, continuous-flow or solid-ink printer, an electrophotographic printer with solid or liquid toner, a dye sublimation, a digital photo printer, a SWOP press, etc.

As mentioned above, a digital swatch book customized to a certain reproduction device/media combination, such as a SWOP press and certain paper, may be displayed on a “workbench” device, e.g. a display of a workstation. The workstation may be arranged to simulate the certain reproduction device/media combination, so that the colors of the swatch book customized to the certain reproduction device/media combination are displayed as close as possible to what would eventually be reproduced when the certain reproduction device/media combination were used.

A computer system to carry out the methods described and thus produce the digital swatch books described may be a usual multi-purpose computer (work station, personal computer, etc.) programmed to perform the color set mappings described and output the digital swatch books as mapping results.

Returning now to FIG. 1, which shows a plane of constant hue in a three dimensional color space. The plane is defined by two orthogonal axes: the lightness axis L and the chroma axis C. The intersection of a reproduction device's color gamut boundary with this plane of constant hue defines a polygonal footprint BD of the device's gamut boundary, this footprint being denoted in the following as gamut boundary curve. Two vertices of this polygon BD reside on the lightness axis L. These two points WD and KD represent the colors of maximum and minimum lightness reproducible by the device, i.e. they are the white point WD and the black point KD of the device's color gamut. The polygon point having the largest (horizontal) distance from the lightness axis L—i.e. the cusp of the gamut boundary curve BD—represents the color of maximum chroma the device can reproduce within the plane of constant hue shown in FIG. 1. In this example the device can reproduce a maximum chroma C_{CuD} of approximately 58 at the depicted hue angle. The cusp position within the chroma-lightness plane may vary with different hue angles depending of the shape of the three-dimensional device gamut, so that the chroma and lightness values of a gamut's cusp at one hue angel may differ from those at another one.

The small white circles in FIG. 1 symbolize individual colors within the depicted hue angle, which belong to a set of catalogue colors distributed throughout the three-dimensional color space. Some of these circles lie outside the polygon BD. These circles represent the colors of the set that are not reproducible by the device. The color set spans a wider lightness range as well as chroma range than the device's gamut, so that the out-of-gamut colors have to be mapped into the device gamut in order to achieve reproducible representations of all the colors in the set.

The white circles are distributed following a certain pattern to symbolize that the colors collected to form the set are chosen according to a certain structure, regulating for instance a minimum/maximum relative color difference to be preserved, or different densities at which the individual colors of the set should populate different hues or lightness levels, or other different regions of the color space.

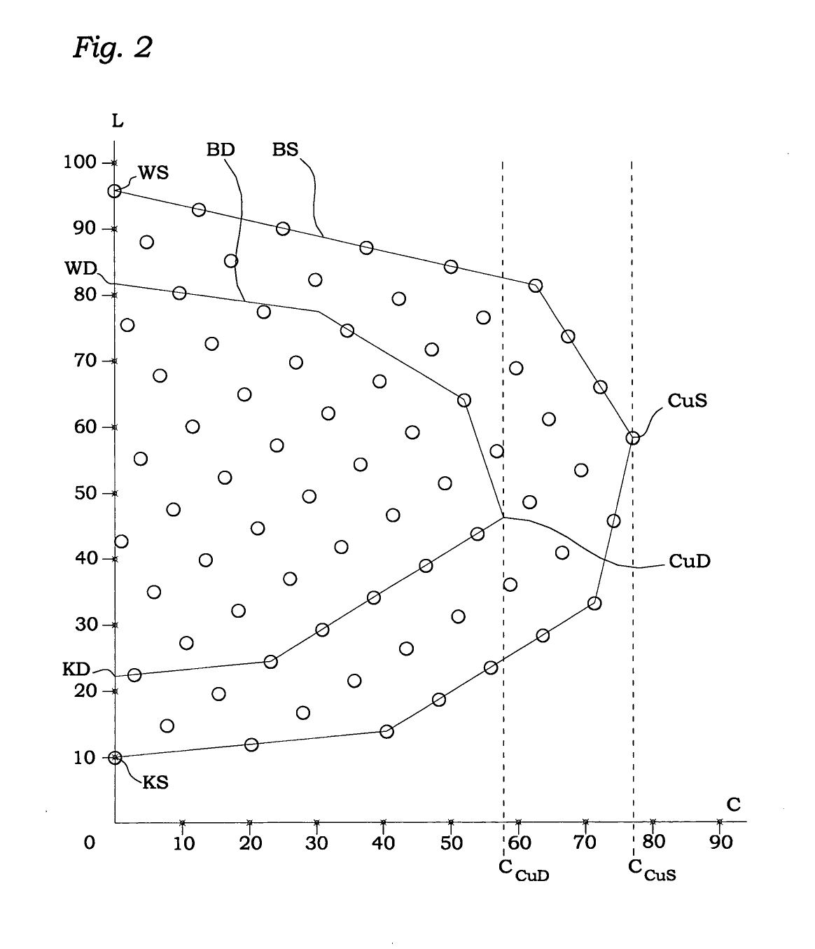

FIG. 2 shows, for the same color set as depicted in FIG. 1, a color set boundary curve BS, which neatly encloses all colors of the set. There exist several known techniques, which the skilled person can adopt for computing the two-dimensional gamut boundary of a given set of colors (e.g. Braun and Fairchild's ‘mountain range’ method or Morovic and Luo's ‘segment maxima’ approach). Intersecting this gamut surface with a plane of given hue then gives the one-dimensional gamut boundary curve BS for the given hue plane.

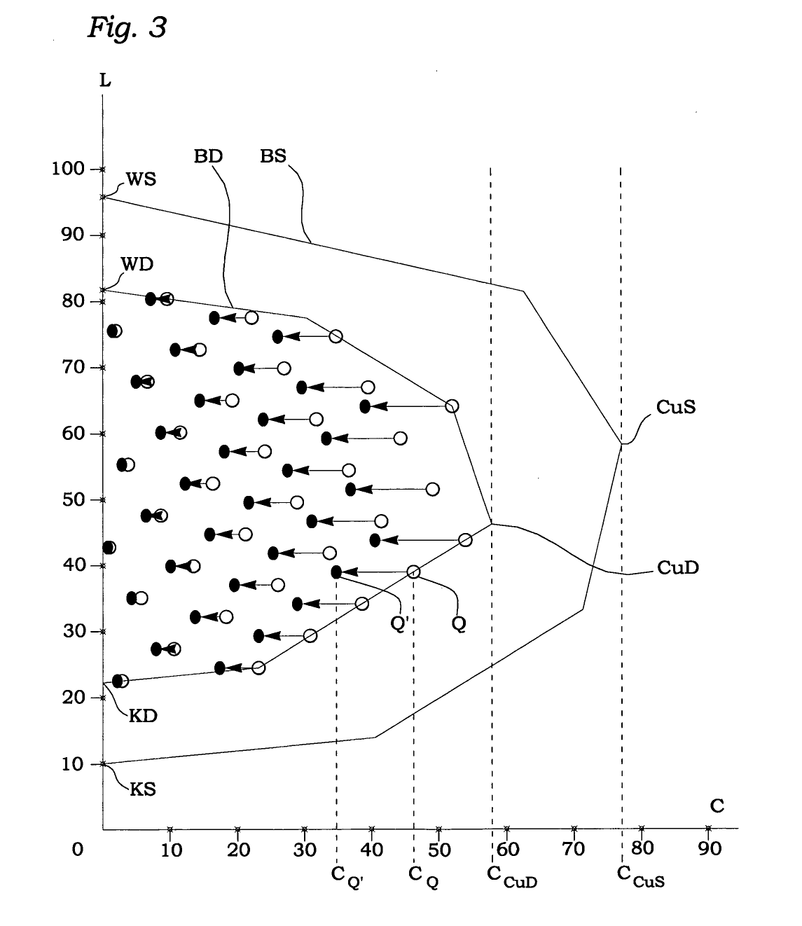

An embodiment of an in-gamut color compression is now described in more detail with reference to FIG. 3. Since the compression only involves colors within the device gamut, the out-of-gamut colors are not shown in the diagram of FIG. 3. All original colors within the device gamut are depicted as white circles, and the corresponding colors subsequent to the compression are shown by black circles. The arrows in FIG. 3 indicate how the compression shifts the original colors towards the L-axis along lines of constant lightness. For each individual standard color, the compression results in a reduced chroma value, meanwhile the lightness value is preserved. One exemplary set color is indicated in FIG. 3 by reference sign Q (source color). Its corresponding destination color subsequent to the compression is indicated by reference sign Q′.

According to the embodiment of FIG. 3, the chroma value C_{Q}′ of each destination color is determined by scaling the source color's chroma value C_{Q} with a given scaling factor C_{CuD}/C_{CuS} which is the ratio of the chroma value C_{CuD} of the cusp of the device color gamut and the chroma value C_{CuS} of the cusp of the color set gamut. For each standard color inside the device gamut, the destination color's chroma value is thus obtained according to the equation C_{Q}′=C_{Q}×C_{CuD}/C_{CuS}, whereby the scaling value C_{CuD}/C_{CuS} is the same for all source colors inside a plane of constant hue.

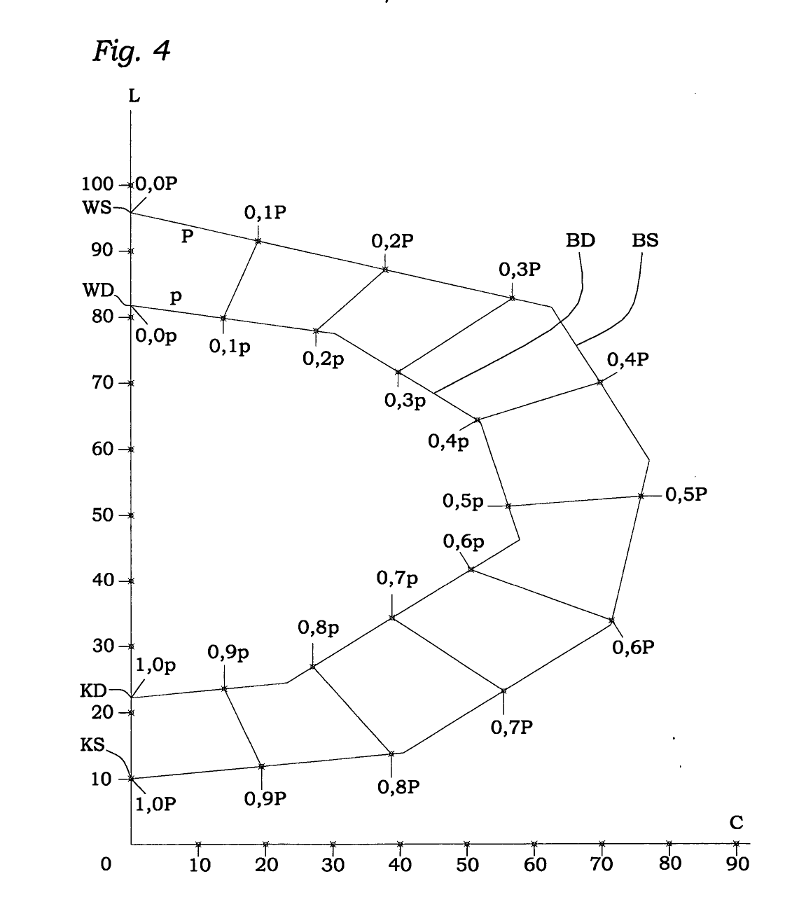

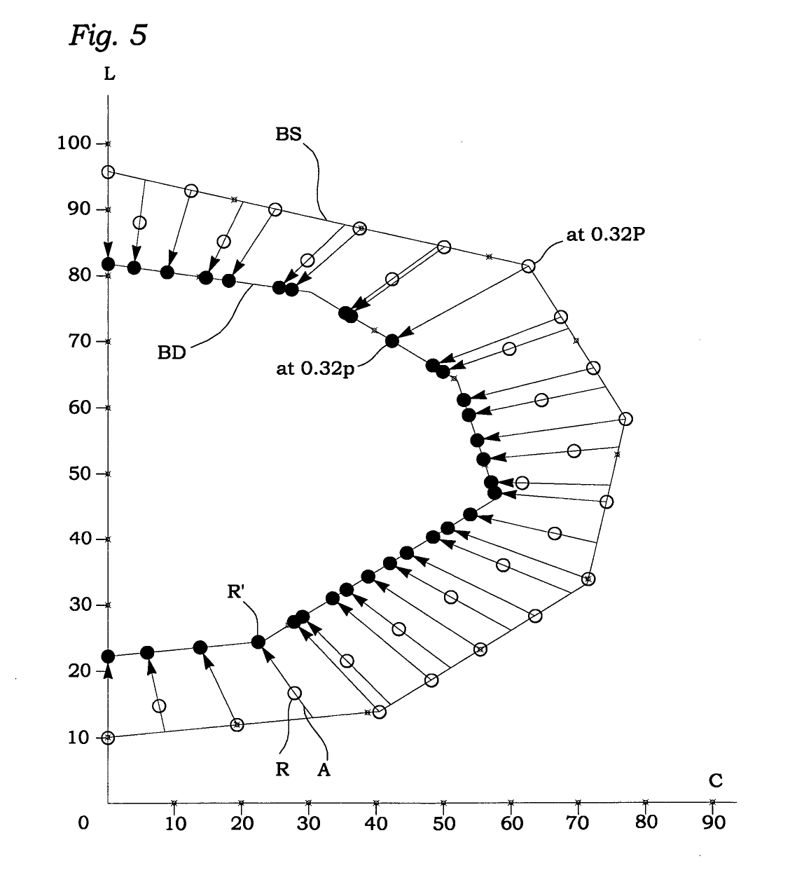

An embodiment of the out-of-gamut color clipping is now described in more detail with reference to FIGS. 4 and 5. The out-of-gamut color clipping involves the standard colors shown in FIG. 2, which are situated outside the device gamut's boundary curve. The aim of the clipping process is to map these out-of-gamut colors onto the device gamut boundary BD. According to this embodiment, path lengths P and p are defined for the boundary curve BS of the set gamut, and, respectively, for the boundary curve BD of the device's gamut. Each path length is defined relative to the total length of the respective gamut boundary curve. The white point WS of the set gamut is defined as the start point of path P, and the black point KS of the set gamut is defined as the end point of path P, such that the relative path length of WS is P=0 and the relative path length of KS is P=1. Similarly, the start and end points WD and KD of the device gamut boundary curve BD correspond to the path length values p=0, and p=1, respectively.

A mathematical approach to construct such a path length is given in the article of Lindsay MacDonald, Ján Morovic and Kaida Xiao; A Topographic Gamut Compression Algorithm; Journal of Imaging Science and Technologies, Volume 46, Number 1, January/February 2002.

According to the embodiment of FIG. 4, an out-of-gamut color is clipped onto the device gamut boundary by shifting the point in color space which represents the color along a straight line (called ‘chord’) which goes through this point and which intersects the two gamut boundary curves BS and BD at points having the same path length p=P. An exemplary set of such chords connecting the two gamut boundaries is depicted in FIG. 4 for relative path lengths p=P=0.0, 0.1, 0.2, . . . , 1.0. Even though only some discrete exemplary chords are shown in FIG. 4, there exists a continuum of such chords, so that there is always one uniquely defined chord per given out-of-gamut color. This chord can for example be obtained by starting with an arbitrary straight line through the point representing the color to be clipped. This starting line will intersect the two gamut boundaries BS and BD at two distinct values p and P. Based on the path length difference, the line can be iteratively rotated until it intersects the gamut boundaries BS, BD at points of equal path length p=P. The resulting line is the chord along which the clipping of the color is finally performed.

An alternative approach for finding an approximation of the chord, which corresponds to a given out-of-gamut color is disclosed in the article of Lindsay MacDonald, Ján Morovic and Kaida Xiao cited above.

With reference to FIG. 5, the clipping result is shown for a number of given out-of-gamut colors. In FIG. 5, the source colors R are shown as white circles whereas the resulting destination colors R′ are shown as black circles. For each of the given source colors R, a corresponding chord is depicted as an arrow A running through the respective color R and pointing from the set gamut boundary BS towards the device color boundary BD. The clipping is performed in such a way that each source standard color R is shifted along its corresponding chord A until it resides on the device gamut boundary BD. The point at which the chord A intersects the device gamut boundary BD thus defines the clipped standard color R′.

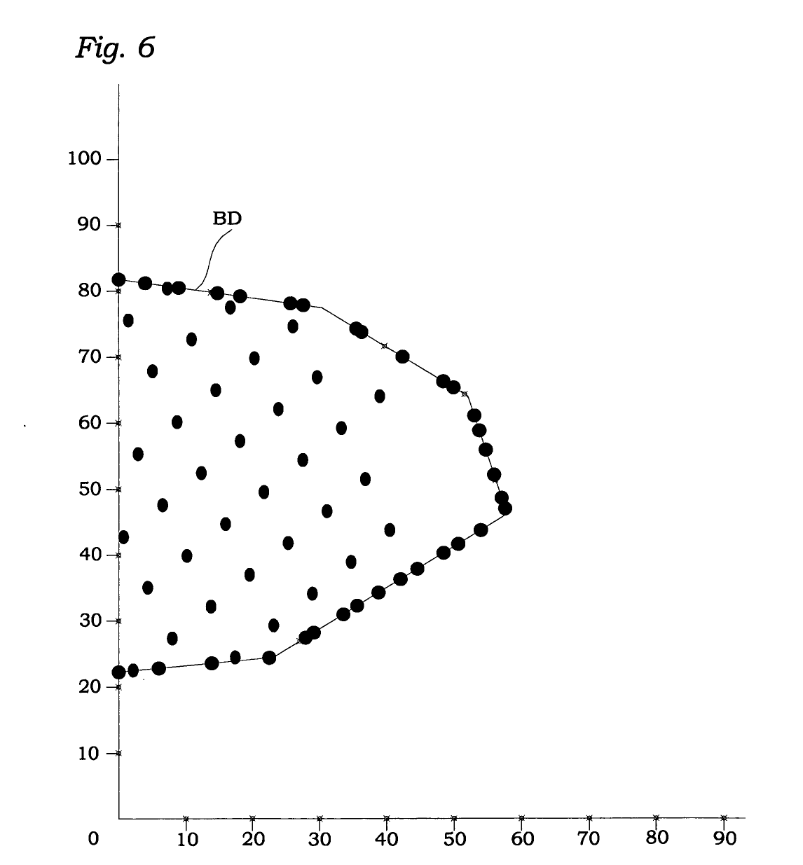

FIG. 6 shows the result of a mapping process which combines the in-gamut compression according to FIG. 3 with the out-of-gamut clipping according to FIGS. 4 and 5. It can be seen in the diagram of FIG. 6, that the in-gamut compression provides space for the colors which are clipped onto the device boundary BD. The clipped colors, which are located on the device gamut boundary BD thus keep distance from the compressed in-gamut colors. The result of the mapping can be considered as a compromise between the aims to preserve the structure and appearance of the original set of standard colors and to exploit the available color gamut of the reproduction device. Furthermore, the compression and the clipping process permits to avoid in many cases that two distinct colors from the standard color set are mapped onto the same single destination color. The combination of in-gamut compression and out-of-gamut clipping as disclosed above thus results in a mapped color set which preserves, to some extent, some of the properties and the structure of the original set of standard colors.

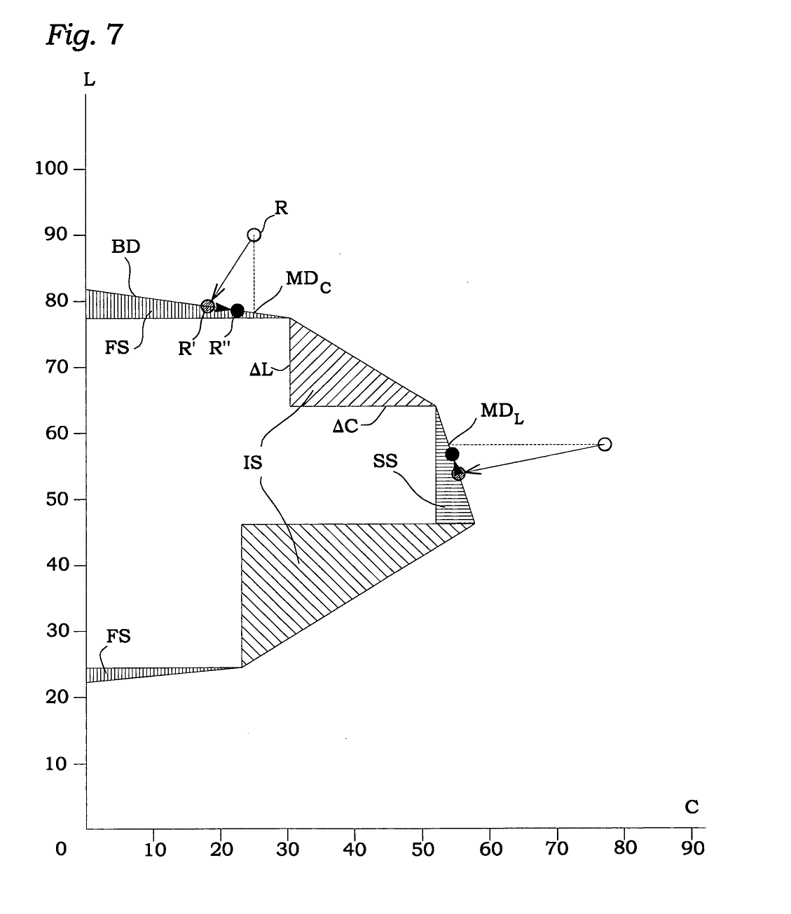

FIG. 7 shows an embodiment of the clipped-color adjustment, which is applied to a set of out-of-gamut colors, which have been clipped onto the device gamut boundary BD. The clipped-color adjustment is performed by shifting a point R′ representing the clipped color along the gamut boundary BD towards the original catalogue color R.

In the diagram of FIG. 7 the gamut boundary curve shown has regions of flatter (FS), intermediate (IS) and steeper slopes (SS). The term ‘slope’ of a gamut boundary curve refers to the slope (ΔL/ΔC) of the gamut boundary curve in the L-C-graph. In the embodiments, the clipped-color adjustment towards the original colors is performed in the regions of flatter slope (FS) and the regions of steeper slope (SS) but not in the regions of intermediate slope (IS). Exemplary values for ‘flatter slope’ where the adjustment is made are ‘smaller or equal 0.2’, and the exemplary values for ‘steeper slope’ (where the adjustment is also made) are ‘greater or equal 5’.

The dashed lines in FIG. 7 indicate the points of minimum difference in either lightness (MD_{L}) or chroma (MD_{C}). In the depicted examples, these minimum differences are zero.

In the embodiment shown in FIG. 7, the adjustment is not made the whole way from the original clipping result R′ to the minimum-difference point MD_{C}, but only a certain fraction of it, to an intermediate point R″ between the original clipping result and the one-dimensional minimum-distance point MD_{C}. In the embodiment of FIG. 7, this fraction is approximately 0.7 but it may also be smaller or larger in other embodiments. Alternatively, the clipped color can be adjusted to the point of one-dimensional minimum-distance MD_{L} to the original color. This would correspond to an adjustment fraction 1.0.

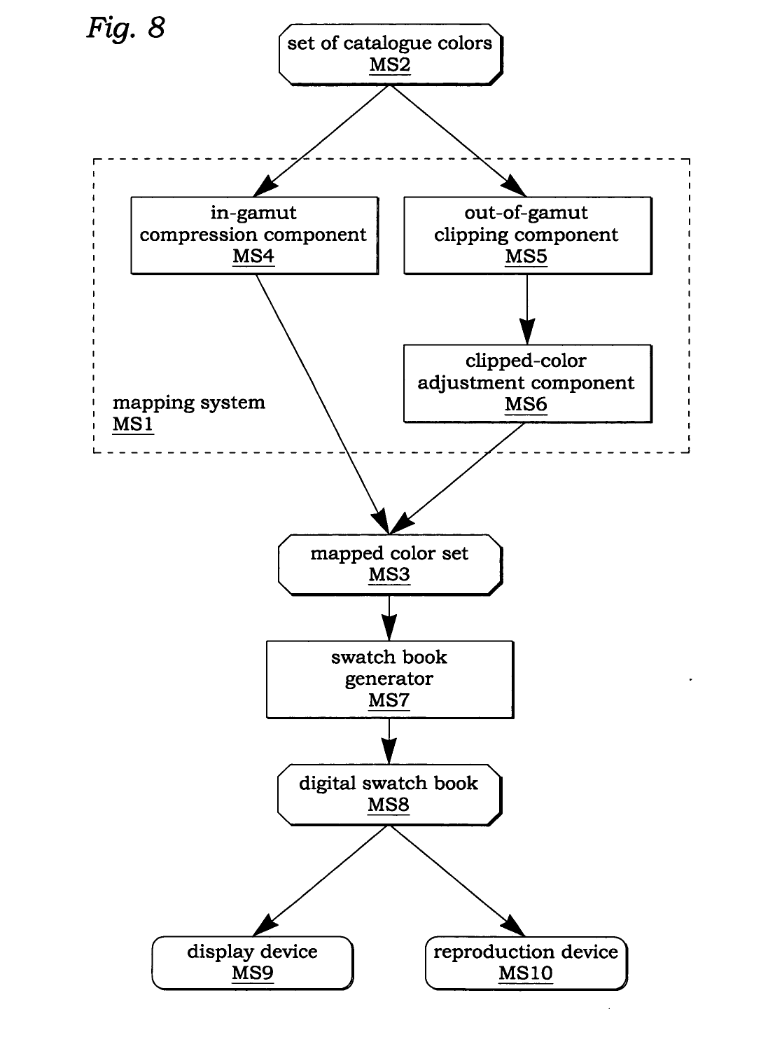

FIG. 8 shows an embodiment of a system MS1 for mapping a set of catalogue colors MS2 comprising colors which are located outside of a reproduction device's color gamut (and are thus not reproducible by the reproduction device MS8) into a set of mapped standard colors MS3 which is located inside the device's gamut (and thus reproducible by the reproduction device MS10). The mapping system comprises an in-gamut compression component MS4 which is arranged to perform a in-gamut color compression as described in detail with reference to FIGS. 3, an out-of-gamut clipping component MS5 which is arranged to perform a out-of-gamut clipping as described with reference to FIGS. 4 and 5, and a clipped-color adjustment component MS6 which is arranged to perform a color adjustment as described with reference to FIG. 7. In the embodiment, a digital swatch book generator MS7 generates from the digital representation MS3 of the mapped color set a digital swatch book MS8. This digital swatch book can for example be a platform-independent data file which is compliant with the XML standard, or it might be a self-contained PDF-file which a user can directly view on a display device MS9 or print on a reproduction device MS10 using a common PDF-reader application. The display device MS9 (e.g. a workstation and a connected monitor) can be arranged to simulate the certain reproduction device MS10 for which the swatch book was produced, so that the colors of the swatch book customized to the certain reproduction device M10 are displayed as close as possible to what would eventually be reproduced when the certain reproduction device MS10 were used.

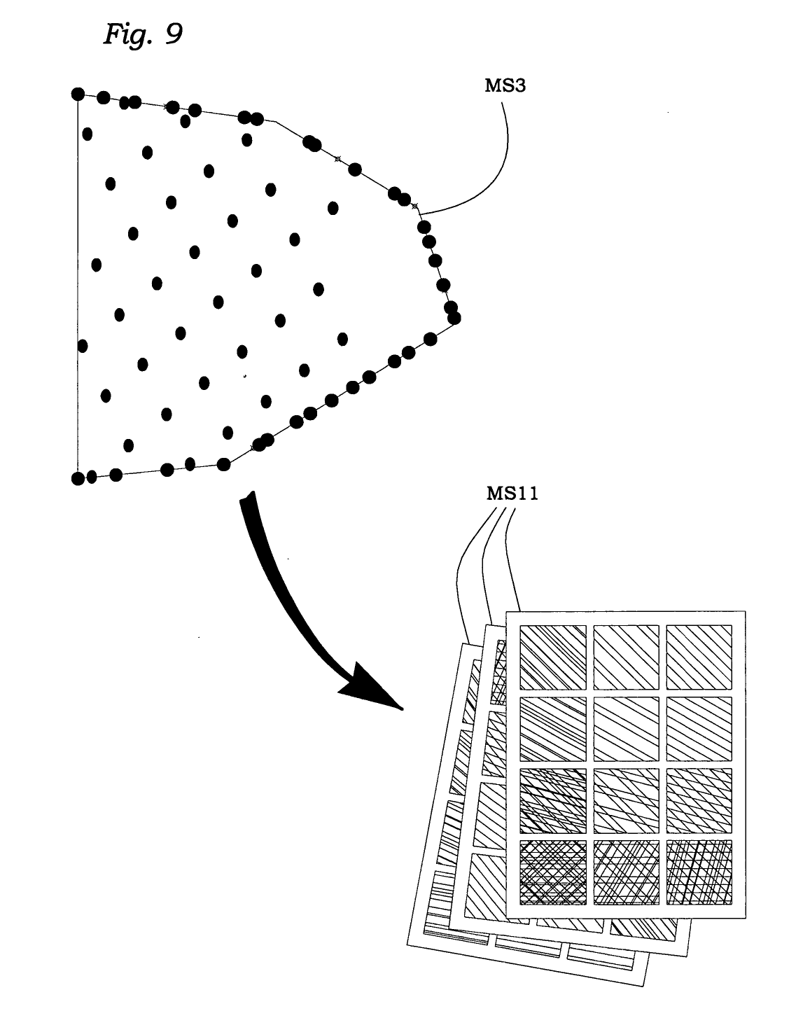

The mapped color set (MS3) of reproducible colors and three exemplary pages of a digital swatch book visualizing some of these colors are depicted in FIG. 9.

Thus, some of the described embodiments provide color set mappings, which are a compromise between color-set-structure preservation, color accuracy, and gamut exploitation.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of mapping a set of individual colors having a color set gamut with a color-set gamut boundary, whereby some of the colors of the color set are not reproducible by a reproduction device having a color gamut with a gamut boundary, and are therefore outside the reproduction device's color gamut, the set of individual colors being mapped to a reproducible-color set, comprising:
compressing the in-gamut colors, and
clipping the out-of-gamut colors onto the device's gamut boundary along lines derived from both of the set gamut boundary and the device's gamut boundary.

2. The method of claim 1, wherein compressing the in-gamut colors comprises, in a two- or three-dimensional color representation using color parameters lightness and chroma, reducing an in-gamut color's chroma without changing its lightness.

3. The method of claim 2, wherein the color set gamut and the reproduction device gamut, at a color parameter ‘hue’ of the in-gamut color considered, each have a cusp at a certain chroma, and wherein the in-gamut color's chroma is reduced by scaling the in-gamut color's chroma by the ratio of the reproduction-device-gamut cusp's chroma and the color-set-gamut cusp's chroma.

4. The method of claim 1, wherein a gamut boundary curve is defined as the intersection of the gamut boundary and a plane of constant hue for both the color set gamut and the reproduction device gamut, said gamut boundary curves connecting a white point and a black point, and, wherein a path length on the gamut boundary curves is defined relative to the total length of the paths connecting the white and black points,
wherein the clipping is performed by shifting a point representing an out-of-gamut color onto the reproduction device's gamut boundary along a line which goes through the point and intersects the color set gamut boundary curve and the reproduction device gamut boundary at the same relative path lengths.

5. The method of claim 1, further comprising:
performing a clipped-color adjustment towards the original colors, depending on the local slope of the reproduction device gamut boundary.

6. A method of mapping a set of individual colors having a color set gamut with a color set gamut boundary, whereby some of the colors of the color set are not reproducible by a reproduction device having a color gamut with a gamut boundary, and are therefore outside the reproduction device's color gamut, the set of individual colors being mapped to a reproducible-color set, comprising:
clipping the out-of-gamut colors onto the device's gamut boundary, and
performing a clipped-color adjustment towards the original colors, depending on the local slope of the device gamut boundary.

7. The method of claim 6, wherein the device gamut boundary has regions of flatter, intermediate, and steeper slopes, and wherein the clipped-color adjustment towards the original colors is performed in at least one of a region of flatter slopes and a region of steeper slopes.

8. The method of claim 7, wherein the clipped-color adjustment towards the original colors is not performed, or is only performed to a lesser extent, in regions of intermediate slope.

9. The method of claim 6, wherein the clipped-color is adjusted by shifting it along the gamut boundary curve to a point of either minimum lightness or minimum chroma difference from the original color, or to an intermediate point between the original clipping result and the minimum-difference point.

10. The method of claim 6, wherein the clipping of the out-of-gamut colors onto the device's gamut boundary is performed along lines derived from both of the set gamut boundary and the device's gamut boundary.

11. The method of claim 6, wherein the colors of the original color set, which are in the reproduction device's gamut are compressed.

12. A digital representation of a set of catalogue colors which is either in the form of a machine-readable medium with the color representations stored on it, or in the form of a propagated signal comprising the color representations, the set of catalogue colors being customized for a reproduction device having a color gamut with a gamut boundary, by mapping an original set of catalogue colors having a color set gamut with a color set gamut boundary to the customized set of catalogue colors, whereby some of the colors of the original color set are not reproducible by the reproduction device, and are therefore outside the reproduction device's color gamut, the mapping being defined by comprising:
compressing the in-gamut colors, and
clipping the out-of-gamut colors onto the device's gamut boundary along lines derived from both of the set gamut boundary and the device's gamut boundary.

13. The digital representation of a set of catalogue colors of claim 12, wherein compressing the in-gamut colors comprises, in a two- or three-dimensional color representation using color parameters lightness and chroma, reducing an in-gamut color's chroma without changing its lightness.

14. The digital representation of a set of catalogue colors of claim 13, wherein the color set gamut and the reproduction device gamut, at a color parameter ‘hue’ of the in-gamut color considered, each have a cusp at a certain chroma, and wherein the in-gamut color's chroma is reduced by scaling the in-gamut color's chroma by the ratio of the reproduction-device-gamut cusp's chroma and the color-set-gamut cusp's chroma.

15. The digital representation of a set of catalogue colors of claim 12, wherein a gamut boundary curve is defined as the intersection of the gamut boundary and a plane of constant hue for both the color set gamut and the reproduction device gamut, said gamut boundary curves connecting a white point and a black point, and, wherein a path length on the gamut boundary curves is defined relative to the total length of the paths connecting the white and black points,
wherein the clipping is performed by shifting a point representing an out-of-gamut color onto the reproduction device's gamut boundary along a line which goes through the point and intersects the color set gamut boundary curve and the reproduction device gamut boundary at the same relative path lengths.

16. The digital representation of a set of catalogue colors of claim 12, wherein the mapping further comprises:
performing a clipped-color adjustment towards the original colors, depending on the local slope of the reproduction device gamut boundary.

17. A digital representation of a set of catalogue colors which is either in the form of a machine-readable medium with the color representations stored on it, or in the form of a propagated signal comprising the color representations, the set of catalogue colors being customized for a reproduction device having a color gamut with a gamut boundary, by mapping an original set of catalogue colors having a color set gamut with a color set gamut boundary to the customized set of catalogue colors, whereby some of the colors of the original color set are not reproducible by the reproduction device, and are therefore outside the reproduction device's color gamut, the mapping being defined by comprising:
clipping the out-of-gamut colors onto the device's gamut boundary, and
performing a clipped-color adjustment towards the original colors, depending on the local slope of the device gamut boundary.

18. The digital representation of a set of catalogue colors of claim 17, wherein the device gamut boundary has regions of flatter, intermediate, and steeper slopes, and wherein the clipped-color adjustment towards the original colors is performed in at least one of a region of flatter slopes and a region of steeper slopes.

19. The digital representation of a set of catalogue colors of claim 18, wherein the clipped-color adjustment towards the original colors is not performed, or is only performed to a lesser extent, in regions of intermediate slope.

20. The digital representation of a set of catalogue colors of claim 17, wherein the clipped-color is adjusted by shifting it along the gamut boundary curve to a point of either minimum lightness or minimum chroma difference from the original color, or to an intermediate point between the original clipping result and the minimum-difference point.

21. The digital representation of a set of catalogue colors of claim 18, wherein the clipping of the out-of-gamut colors onto the device's gamut boundary is performed along lines derived from both of the set gamut boundary and the device's gamut boundary.

22. The digital representation of a set of catalogue colors of claim 18, wherein the colors of the original color set, which are in the reproduction device's gamut are compressed.
